(19) United States
(12) Patent Application Publication
(10) Pub. No.: US 2006/0049001 A1
(43) Pub. Date: Mar. 9, 2006

(54) Driven pendulum apparatus and method of operation thereof

(76) Inventor: Mark Streitman, East Brunswick, NJ (US)

Correspondence Address: SPERRY ZODA AND KANE;SUITE D, ONE HIGHGATE DRIVE, TRENTON, NJ, 08618, US

(21) Appl. No.: 10/936,926

(22) Filed: Sep. 9, 2004

(51) Int. Cl. F03G 3/00

(52) U.S. Cl. 185/29; 368/165

(57) ABSTRACT

A pendulum apparatus and method of operation which is driven to compensate for frictional and other losses to maintain the pendulum operating over extended periods of time. The method and apparatus is particularly useful in the operation of Foucault pendulums. A vertically movable member is driven and a controller is provided which operates initially in the calibration mode for determining the natural frequency of the pendulum apparatus and is then operated in the driving mode. The pivot mechanism is relatively inexpensive and reliable and includes an adapter member with a mounting membrane of flexible material and defining a membrane aperture. A suspension line is secured extending through this aperture and a bob is secured thereto.

### BACKGROUND OF THE INVENTION

1. Field of the Invention

The present invention deals with the field of pendulums and more particularly the field of driven pendulums. Such devices need to operate over extended periods of time. Such pendulums are commonly utilized with clocks and, more specifically, with a Foucault pendulum which can be configured experimentally to display the effects of rotation of the earth and the resulting Coriolis Effect. The present invention provides an improved apparatus for driving and facilitating pivoting of a pendulum such as a Foucault pendulum which includes a unique method of set up and calibration as well as operation thereof.

2. Description of the Prior Art

Some devices have been patented dealing with driven pendulums some of which describe Foucault pendulums and calibration techniques such as shown in U.S. Pat. No. 3,952,234 patented Apr. 20, 1976 to D. J. Birchall on “Pressure Transducers”; and U.S. Pat. No. 4,744,248 patented May 17, 1988 to R. E. Stewart and assigned to Litton Systems, Inc. on a “Vibrating Accelerometer-Multisensor”; and U.S. Pat. No. 4,744,249 patented May 17, 1988 to R. E. Stewart and assigned to Litton Systems, Inc. on a “Vibrating Accelerometer-Multisensor”; and U.S. Pat. No. 4,967,605 patented Nov. 6, 1990 to K. Okada and assigned to Wacoh Corporation on a “Detector For Force And Acceleration Using Resistance Element”; and U.S. Pat. No. 4,969,366 patented Nov. 13, 1990 to K. Okada and assigned to Wacoh Corporation on a “Moment Detector Using Resistance Element; and U.S. Pat. No. 5,182,515 patented Jan. 26, 1993 to K. Okada and assigned to Wacoh Corporation on a “Detector For Magnetism Using A Resistance Element”; and U.S. Pat. No. 5,163,375 patented Nov. 23, 1993 to K. Okada and assigned to Wacoh Corporation on a “Contact Detector Using Resistance Elements And Its Application”; and U.S. Pat. No. 5,295,386 patented Mar. 22, 1994 to K. Okada on an “Apparatus For Detecting Acceleration And Method For Testing This Apparatus”; and U.S. Pat. No. 5,531,092 patented Jul. 2, 1996 to K. Okada on a “Device For Moving A Suspended Weight Body”; and U.S. Pat. No. 5,571,972 patented Nov. 5, 1996 to K. Okada on a “Sensor Using Piezoelectric Elements”; and U.S. Pat. No. 5,646,346 patented Jul. 8, 1997 to K. Okada on a “Multi-Axial Angular Velocity Sensor”; and U.S. Pat. No. 5,668,318 patented Sep. 16, 1997 to K. Okada and assigned to Wacoh Corporation on an “Angular Velocity Sensor”; and U.S. Pat. No. 5,744,718 patented Apr. 28, 1998 to K. Okada on a “Sensor Using A Resistance Element”; and U.S. Pat. No. 5,780,749 patented Jul. 14, 1998 to K. Okada on a “Sensor Using Piezoelectric Elements”; and U.S. Pat. No. 5,811,693 patented Sep. 22, 1998 to K. Okada on a “Force Detector And Acceleration Detector And Method Of Manufacturing The Same”; and U.S. Pat. No. 5,831,163 patented Nov. 3, 1998 to K. Okada on a “Multi-Axial Angular Velocity Sensor”; and U.S. Pat. No. 5,850,040 patented Dec. 15, 1998 to K. Okada and assigned to Wacoh Corporation on a “Multiaxial Acceleration Sensor Using A Piezoelectric Element”; and U.S. Pat. No. 5,856,620 patented Jan. 5, 1999 to K. Okada and assigned to Wacoh Corporation on an “Acceleration Sensor”; and U.S. Pat. No. 5,987,985 patented Nov. 23, 1999 to K. Okada on an “Angular Velocity Sensor”; and U.S. Pat. No. 6,003,371 patented Dec. 21, 1999 to K. Okada and assigned to Wacoh Corporation on an “Angular Velocity Sensor”; and U.S. Pat. No. 6,205,856 patented Mar. 27, 2001 to K. Okada and assigned to Wacoh Corporation on an “Angular Velocity Sensor”; and U.S. Pat. No. 6,269,697 patented Aug. 7, 2001 to K. Okada and assigned to Wacoh Corporation on an “Angular Velocity Sensor Using Piezoelectric Element”; and U.S. Pat. No. 6,282,956 patented Sep. 4, 2001 to K. Okada on a Multi-Axial Angular Velocity Sensor”.

### SUMMARY OF THE INVENTION

The present invention discloses a driven pendulum apparatus which includes a vertically movable member which preferably is resiliently mounted with respect to the pendulum housing. A drive means is included which is operatively connected with respect to the vertically movable member for the purpose of powering the vertical movement of the vertically movable member preferably by actuation of a coil. Actuation of such a coil would inductively drive vertical movement of the vertically movable member as required in a cyclical manner for maintaining the momentum of the pendulum by driving thereof. This coil will preferably generate an electromagnetic field responsive to actuation thereof to power this vertical movement.

Also a sensing device is included in the present invention which is operatively attached with respect to the vertically movable member to monitor vertical movement thereof responsive to forces exerted thereon. This sensing means is operationally connected to the drive means directly or inductively.

An adapter member is also included within the construction of the pendulum apparatus of the present invention and it is secured to the vertically movable member to be movable therewith. This adapter member preferably includes an adapter body which is securable directly to the vertically movable member as well as a mounting cap detachably securable with respect to the adapter body and positionable extending around the mounting membrane for facilitating detachable securement thereto.

This mounting membrane preferably will comprise a nipple shaped member detachably mounted between the mounting cap and the adapter body of the adapter member and extending downwardly therefrom such as to be movable vertically along with the adapter. This mounting member is preferably formed of a flexibly resilient rubber material to facilitate pivotal movement of the portion of the pendulum extending downwardly therefrom. To facilitate securement with respect thereto, the mounting membrane preferably will define a membrane aperture therein. A suspension line is also provided positioned extending through the membrane aperture defined in the mounting membrane and extending outwardly and downwardly therefrom. A line securement device is further included for detachably retaining the suspension line in position extending through the membrane aperture of the mounting membrane and further extending downwardly therefrom. This line securement device will preferably include a retaining bead having a size larger than the membrane aperture defined in the mounting membrane and being securable to the suspension line at a position above the membrane aperture in order to facilitate retaining of the suspension line in position extending downwardly therefrom. The retaining bead preferably defines a bead hole extending therethrough which is adapted to receive the suspension line extending therethrough to facilitate detachable securement thereto.

A bob is also included detachably securable with respect to the suspension line at a position below the membrane aperture to facilitate cyclical pivotal movement of the suspension line and the bob as a unit with respect to the membrane aperture from which it extends downwardly which forms the pivotable pendulum.

A control device is also included in the present invention which is operatively connected with respect to the drive and the sensor for controlling cyclical operation of the bob of the driven pendulum. This control device is initially placed in calibration mode wherein the sensing device is rendered operative to sense the vertical movement of the vertically movable member in order to determine the natural oscillation frequency of the pendulum. Thereafter the control device is moved to the operating mode wherein the drive is rendered operative to cyclically drive the vertically movable member for driving of the bob of the pendulum with the sensing means rendered inoperative.

Furthermore the present invention may include a temperature monitoring device which is operatively connected with respect to the control means wherein the control means is operative to increase the period of cyclical driving of the driving device responsive to an increase in the ambient temperature and wherein the control means is operative to decrease the period of cyclical driving of the driving device responsive to a decrease in ambient temperature.

In the present invention the mounting cap preferably defines a cap opening therein which is adapted to receive the mounting membrane extending outwardly therethrough to facilitate mounting thereof with respect to the adapter body. This means of securement preferably is provided by the adapter body defining body threads therein and the mounting cap defining cap threads therein. The body threads and the cap threads are preferably engageable with respect to one another selectively to facilitate detachable securement of the mounting cap and the mounting membrane to the adapter body.

To further facilitate this mounting the mounting membrane itself may preferably include a mounting rim which is adapted to be positioned between the mounting cap and the adapter body to facilitate detachable securement of the mounting membrane with respect to the adapter body and the vertically moving member.

The bead of the present invention preferably is formed of a metallic material such as brass and defines a bead hole extending therethrough to facilitate securement of the suspension line thereto. Alternatively, the bead could be of a polymer, a thermoplastic material or a ceramic material. Also, the bead shape can be cylindrical or round, however, a generally rounded shape normally will be useful in reducing overall friction during pendulum movement. The suspension line itself is formed, preferably, of a metallic or nylon material but can be also of any thermoplastic or polymer material. The suspension line can also be of a single stranded design or it can be wound or woven. It has been determined that an alloy of nickel and titanium such as nitinol is particularly useful for forming the suspension line. The control means may also include a manual adjustment mechanism to facilitate fine tuning manually of the frequency of operation of the drive means such that it coincides closely with the natural frequency of the pendulum. Also an indicator light is preferably included to signal that the bob means has reached the highest point in cyclical movement thereof during operation of the apparatus in the calibration mode. This high point is normally located at the two outwardly opposite extreme positions and the indicator light provides a means for showing that these points have been reached by the bob itself. During the operational mode the indicator light is operable to indicate when the pendulum is being momentarily driven.

In operation the pendulum of the present invention is initially manually swung to one side causing the start of cyclical movement of the pendulum as extending downwardly from the vertically movable member thereabove. At this point the control means will be in the calibration mode and the forces exerted on the vertically movable member over a given period of time by the pendulum will allow the controlling device through the sensing device to determine the natural frequency of the pendulum. Once this natural frequency has been determined the control mechanism will move to the operational mode wherein the vertically movable member will be powered to move in correspondence with the natural frequency of the pendulum extending therebelow.

Normally one cycle of movement of the pendulum extends from one side to the bottom to the opposite side to the bottom and back to the original side. The vertically movable member must have a similar frequency and must be properly timed or phased to the cyclical movement of the pendulum to facilitate powering thereof. At those times when the pendulum reaches the lowermost point twice in the cycle of pendulum movement, the vertically movable member should be driven upwardly to reset. On the other hand, at those times when the pendulum reaches the outermost or highest extreme positions the pendulum should be driven downwardly to allow gravitational forces to add energy to the pendulum. This pumping action adds energy to the pendulum to compensate for energy losses occurring for many reasons such as from friction. It has been further determined that the driving of the pendulum is significantly enhanced by initiating the downward movement of the vertically movable member immediately prior to the pendulum bob reaching the extreme extent of swing in each opposite direction. Similarly it has been determined that driving is further enhanced by initiating upward movement of the vertically movable member immediately prior to the bob reaching the lowermost position. Normally the timing of this advance driving is minimal being between 0.1 and 2.0 milliseconds.

It is an object of the present invention to provide a driven pendulum apparatus and method of operation thereof wherein the initial capital costs of equipment is minimized.

It is an object of the present invention to provide a driven pendulum apparatus and method of operation thereof wherein maintenance costs are minimized.

It is an object of the present invention to provide a driven pendulum apparatus and method of operation thereof wherein displaying the attributes of a Foucault pendulum is enhanced.

It is an object of the present invention to provide a driven pendulum apparatus and method of operation thereof wherein an inexpensive reliable pivot is provided which minimizes the decay of movement of a pendulum or Foucault pendulum.

It is an object of the present invention to provide a driven pendulum apparatus and method of operation thereof wherein the period of driving of the pendulum and the natural frequency of the pendulum can be easily matched without requiring changing of the position of attachment of the bob to the suspension line.

It is an object of the present invention to provide a driven pendulum apparatus and method of operation thereof wherein a control device is provided which initially senses forces on the vertically moving member without driving thereof to determine the natural frequency of the pendulum and which is thereafter put in operation mode to drive the vertically movable member in coordination with the so determined natural frequency.

It is an object of the present invention to provide a driven pendulum apparatus and method of operation thereof which can be used to scientifically display fully the attributes of a Foucault pendulum.

It is an object of the present invention to provide a driven pendulum apparatus and method of operation thereof which can be easily assembled and disassembled.

It is an object of the present invention to provide a driven pendulum apparatus and method of operation thereof which is particularly adaptable for the replacement of parts as needed easily because of the ease of disassembly and re-assembly of the pivoting mechanism and pendulum construction.

It is an object of the present invention to provide a driven pendulum apparatus and method of operation thereof which makes it very easy for an operator to assemble and disassemble the apparatus and to set up and maintain operation of the apparatus for long periods of time.

### BRIEF DESCRIPTION OF THE DRAWINGS

While the invention is particularly pointed out and distinctly claimed in the concluding portions herein, a preferred embodiment is set forth in the following detailed description which may be best understood when read in connection with the accompanying drawings, in which:

FIG. 1 is a front plan view of an embodiment of the pendulum apparatus of the present invention showing the driver, sensor and control device in schematic illustration;

FIG. 2 is a force diagram of the pendulum showing the forces at various points throughout the cyclical movement of the pendulum bob;

FIG. 3 is a front plan view of an alternative embodiment of the pendulum apparatus of the present invention showing a socket defined in the mounting membrane for movably receiving and holding of the retaining bead therewithin;

FIG. 4 is a front plan view of an embodiment of the present invention showing an embodiment of the pendulum bob with an external mass resiliently connected to the exterior thereof;

FIG. 5 is a front plan view of an embodiment of the present invention showing an embodiment of the pendulum bob with an internal mass resiliently connected within a chamber defined therewithin;

FIG. 6 is a front plan view of an embodiment of the present invention showing an embodiment of the pendulum bob with a movable mass positioned within a void defined within the bob interior; and

FIG. 7 is a front plan view of an embodiment of the present invention showing an embodiment of the pendulum bob with a unique means for securing the bob to the end of the suspension line utilizing a securement means such as a knot or glue and two abutting bearings between the securement means and the interior of the bob within the chamber means thereof.

### DETAILED DESCRIPTION OF THE PREFERRED EMBODIMENT

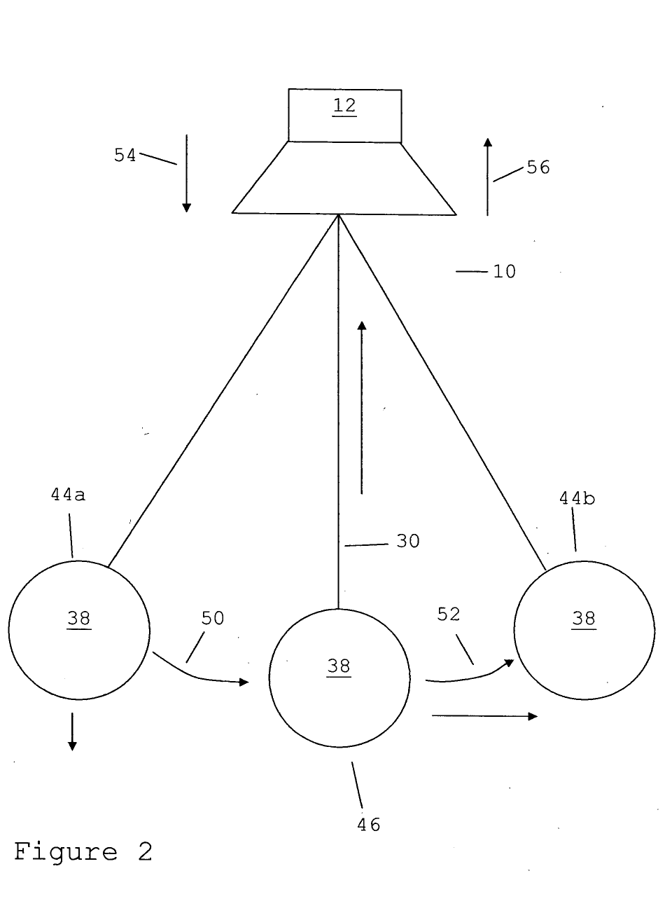

The present invention provides a unique apparatus for providing an inexpensive and reliable pendulum apparatus and method for operation thereof which is particularly adaptable for use as a Foucault pendulum apparatus. With this apparatus the pendulum 10 moves through a path shown best in FIG. 2. This path runs from the highest pendulum point on the left portion of FIG. 2 noted as point 44a. The pendulum then will move downwardly through an arc generally along the path shown by arrow 50 to the lowermost point 46. Thereafter the pendulum will move upwardly as shown by arrow 52 to the pendulum highest point 44b on the righthand side of FIG. 2. Thereafter the pendulum will again move downwardly in the opposite direction of arrow 52 toward point 46 and then upwardly in the opposite direction with respect to arrow 50 to return to original starting point 44a. This is determined to be a single period of oscillation of the pendulum 10 and, in particular, of the pendulum bob 38 which is secured with respect to a suspension line 30 extending downwardly from the point of pivot thereabove.

A vertically movable member 12 will be provided movable in accordance with down arrow 54 and up arrow 56 cyclically. In order to pump the pendulum 10 and increase the energy therein slightly during each cycle of operation, the vertically movable member 12 is movable up and down in the direction as shown by arrows 54 and 56. Initially, as the pendulum bob 38 moves from point 44a to point 46 along arrow 50 as it reaches point 46 the vertically movable member 12 will preferably be moved upwardly in a vertical direction. This should be timed approximately to coincide with when the pendulum bob 38 reaches point 46 or a very slight fraction of a second before that point. This action will reset the vertically movable member in the upper position.

As the bob 38 moves upwardly along the path of arrow 52 as it reaches point 44b the vertically movable member 12 will be moved downwardly in the direction shown by arrow 54. This will allow the pendulum bob 38 to free fall downwardly for a very short distance thereby adding additional kinetic energy into the pendulum. The bob 38 will then move downwardly again toward the lowest point 46 and, as it reaches that point or immediately prior to reaching point 46, the vertically movable member 12 will be again driven upwardly as shown by arrow 56 to reset the vertically movable member in the uppermost position thereof. Thereafter when the bob 38 reaches point 44a again the vertically movable member 12 can be driven downwardly as shown in arrow 54 to impart additional energy to the pendulum. This pumping action will require that the vertically movable member 12 be moved upwardly and downwardly in a coordinated manner with respect to the cyclical movement of the pendulum bob 38. The frequency of the alternating driving of the vertically movable member 12 normally will occur at approximately twice the frequency of the pendulum. That is, the vertically movable member 12 will be moved initially in direction 54 and then in direction 56, then direction 54 and finally in direction 56 during one cycle of coordinated movement of the pendulum bob 38 toward point 46 and thereafter point 44b and thereafter 46 and returning to point 44a. The frequency of driving of the vertically movable member 12 can be cut in half, or further reduced if less additional energy is needed. The frequency of driving can also be set to occur less than once during each natural period with some applications. However, normally it will cycle at twice the speed of the pendulum frequency so that force can be applied at each extreme end of the swing movement path of the bob 38.

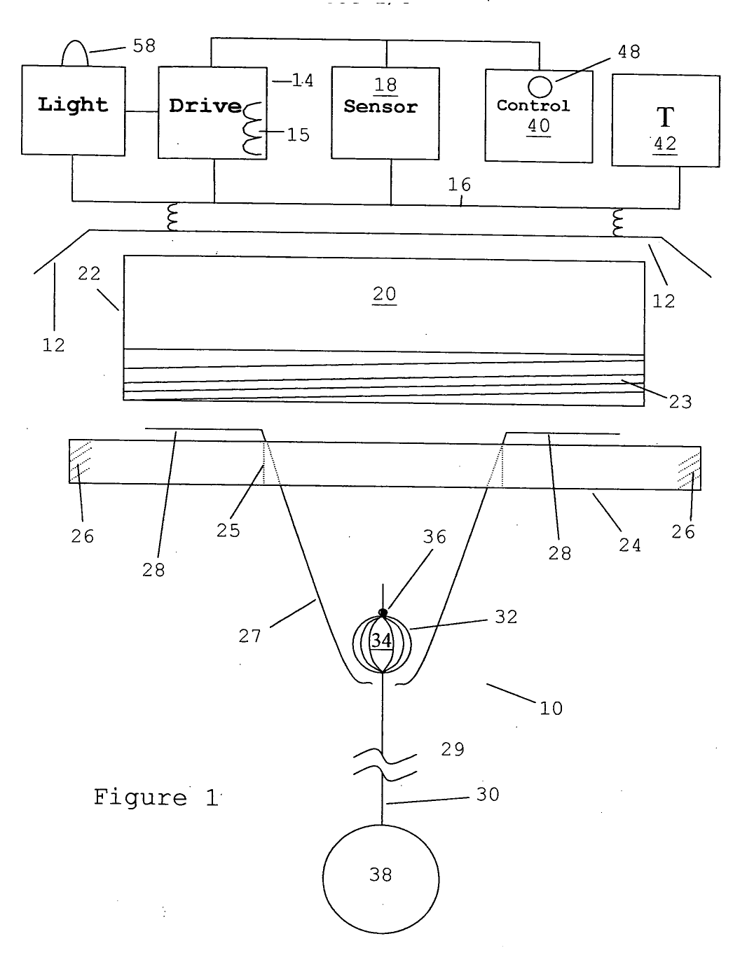

One of the unique aspects of the present invention is in the improved controlling and sensing mechanism for coordinating the movement of the vertically movable member 12 relative to the pendulum apparatus 10. In particular, a drive device 14 is operatively connected with respect to the vertically movable member 12 to cause movement thereof in direction 54 and/or direction 56. This drive means can be a direct mechanical coupling but, more preferably, is an inductive driving resulting from the generation of electromagnetic field by a coil means in the driving device 14. In the schematic drawings shown in FIG. 1, the coil is included within the driving device 14. Driving device 14 is the sole powering means for driving of the vertically movable member 12 in directions 54 and 56.

The present invention also includes a unique configuration for the pendulum construction itself wherein the pendulum housing 16 is provided to which the vertically movable member 12 is preferably resiliently mounted. A sensing device 18 is operatively connected to the vertically movable member to sense the vertical forces exerted thereupon during times when it is not being driven by the driving device or drive means 14.

The actual construction for suspension of the apparatus of the present invention includes an adapter body 20 which is attached such as by gluing or otherwise to the undersurface of the vertically movable member 12. Adapter member 20 can be attached to the vertically movable member 12 by various means possible. However, gluing directly to the vertical movable member 12 is another option for securement. The adapter member 20 preferably includes an adapter body 22 which includes body threads 23 extending about the outer surface thereof. A mounting cap 24 includes cap threads 26 defined thereon which are mated with respect to the body threads 23 such as to be engageable therewith. Engaging of the cap threads 26 of the mounting cap 24 with respect to the body threads 23 of the adapter body 22 will cause the cap to be secured to the body as desired. This construction provides a means for easy attachment or detachment of the mounting membrane 27 with respect to the vertically movable member 12.

Preferably the mounting cap 24 will define a cap opening 25 extending therethrough and the mounting membrane 27 will define a mounting rim 28 of material designed to be positioned between the mounting cap 24 and the adapter body 22. In this manner securement of the mounting cap 24 with respect to the adapter body 22 by engagement of cap threads 26 with respect to body threads 23 will detachably secure the mounting membrane 27 with respect to the vertically movable member 12.

The configuration of the mounting membrane 27 is an important advancement of configuration of the present invention. Preferably the membrane will extend downwardly and be formed of a flexibly resilient material to facilitate pivotal movement of the pendulum bob 38 and suspension line 30 extending downwardly therefrom. The mounting membrane 27 preferably is in the shape of a nipple or downwardly facing cone which defines a membrane aperture 29 at the lowermost point thereon. This membrane aperture is adapted to receive a suspension line 30 extending therethrough. A retaining bead 34 is secured to the suspension line 30 at a position immediately above the membrane aperture 29 which provides a line securement means 32. This line securement means 32 provides the preferably detachable means of securement of the suspension line 30 with respect to the mounting membrane 27. The mounting membrane being of a flexible material preferably rubber or other pliable material makes use of the flexible resilience thereof to dampen any unwanted vibrations or movements of the suspension line 30 and/or of the bob 38 secured thereto and to reduce friction during cyclical pendulum movements. Bob 38 is secured to the suspension line 30 at a position substantially below the mounting membrane 27 and in this manner form the pivoting configuration of the pendulum which is particularly adaptable for displaying the characteristics of a Foucault pendulum.

As such, the construction of this pivoting mechanism for the pendulum of the present invention is easy to assemble and is made of inexpensive parts and provides a reliable and yet inexpensive means for illustrating the principles and characteristics of a driven pendulum and, in particular, of a driven Foucault pendulum. In operation the control means 40 of the present invention is preferably an electronic control mechanism such as a central processing unit of a computer which facilitates accurate and convenient control of operation of the drive 14 and facilitates monitoring of the information conveyed from sensor 18. This control means 40 is operationally connected to both the drive means and the sensor means for achieving this purpose. Also an ambient temperature monitoring means 42 may be included which is useful in supplying temperature information to the controller such that the controller can automatically modify the frequency of driving of the drive means to compensate for any such temperature changes as they occur.

It is also useful in the apparatus of the present invention to provide an indicator 58 such as an indicator light which shows when the pendulum bob 38 reaches the opposite extreme points of movement 44a and 44b when in the calibration mode. The light or other indicator means 58 will yield a signal whenever the pendulum bob 38 is at or near positions 44a or 44b. This light 58 is designed to be lighted during operational mode when the pendulum is being driven responsive to downward movement of the vertically movable member and during calibration mode is operable to indicate the outer extreme positions of bob movement.

The actual construction of the pivot mechanism can be significantly enhanced by providing a retaining bead 34 which defines a bead hole 36 extending therethrough. This bead hole is preferably approximately equal to the diameter of the suspension line 30 to facilitate securement with respect thereto. One configuration which has been shown to be particularly advantageous is to form the bead 34 of a metallic material such as brass with the bead hole 36 being slightly smaller than the diameter of the suspension line 30. Securement of retaining bead 34 to the suspension line 30 is achieved by heating of the retaining bead 34 which expands the diameter of the bead hole 36 such that the suspension line 30 can be threaded therethrough. Thereafter the retaining bead 34 is allowed to cool which causes the retaining bead 34 to firmly grip the external surface of suspension line 30. In this manner the line securement means 32 is easily provided in a manner which facilitates detachment thereof and pivotal movement of the suspension line 30 against the interior surface of the mounting membrane 27 immediately adjacent to the membrane aperture 29 is enhanced and frictional forces are minimized.

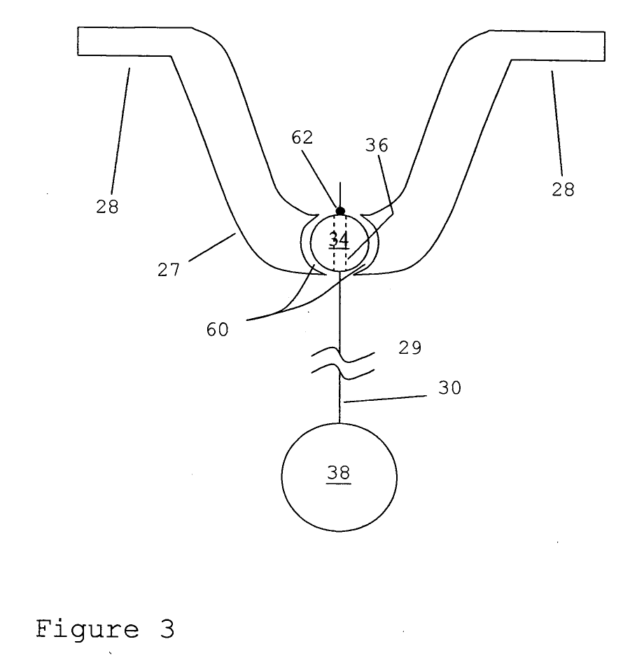

An alternative construction for the line securement means 32 is shown in FIG. 3 wherein a retaining socket 60 is defined in the flexibly resilient mounting membrane means 27 for detachably receiving the retaining bead 34 thereinto. This constructions makes use of a retaining bead 34 which is generally rounded in shape and is secured to the suspension line 30 by any conventional means. As shown in FIG. 3 the line can extend through bead hole means 36 and a knot 62 can be formed in the suspension line immediately above the retaining bead 34 for attachment therewith. The retaining bead 34 can then be placed into the retaining socket 60 defined in the flexible membrane to facilitate cyclical movement of the pendulum during operation. This ball and socket construction is particularly advantageous because the bead 34 can be allowed to rotate to some extent while being retained within the retaining socket 60 to facilitate swinging motion of the suspension line 30 and bob 38 while minimizing frictional losses.

In operation the controller of the present invention is preferably operable initially in a calibration mode. In this calibration mode the drive 14 is de-activated. The operator will manually initiate swinging of the pendulum bob 38 by moving of pendulum bob 38 and suspension line 30 to either of the extreme positions 44a or 44b. This positioning initiates cyclical movement of the pendulum 10 through the pendulum path of movement between points 44a and 44b without any driving thereof. As this movement initiates sensor 18 will monitor the forces exerted on the resiliently mounted vertically movable member 12 in order to communicate this information to the control device 40. The control device 40 will use this information in order to determine the natural frequency of the pendulum 10. Once this frequency has been determined the controller 40 will move from the calibration mode to the operational mode and the drive means 14 will initiate cyclical vertical movement of the vertically movable member 12 in a coordinated manner with respect to this natural frequency which has only immediately therebefore been determined during the calibration stage. Preferably the drive means 14 will move the vertically movable member 12 through a cycle at approximately twice the frequency of the natural frequency of the pendulum. In some circumstances minor modifications of the driving frequency need to be made and for this reason a manual fine tuning means 48 may be operationally included in the control means 40.

It should be appreciated that the suspension line 30 can be formed of any material such as very fine nylon or metal wire. One of the materials found to be particularly advantageous for the present invention is a shaped memory alloy of titanium and nickel commonly referred to as nitinol. This material has minimal kinking and is particularly useful for minimizing the frictional force losses of a pendulum such as a Foucault pendulum.

The temperature monitoring means 42 of the present invention is particularly useful for monitoring changes in ambient condition once the calibration step has terminated. The temperature monitoring means 42 will convey increases in temperature to the control device 40 and the control device will increase the period to compensate for these increases in temperature. On the other hand, if the temperature monitoring means 42 senses decreases in temperature the period will need to be shortened.

As such, the present invention provides a distinct improvement in the method of calibration and initial operation and setup of a Foucault or other similar pendulum while at the same time providing a relatively inexpensive and easily assembled pendulum pivoting and driving construction.

The present invention is designed to provide a visible means of displaying the existence of the Coriolis force. This force is very weak responsive to normally experienced environmental forces and, as such, the present invention is particularly designed to illustrate this force despite the small magnitudes thereof. It is common that localized environmental forces will cause the pendulum to stop turning or to in other ways inhibit the pendulum operation. One of the most difficult forces to deal with is the forces resulting from friction. Environmental forces can normally include static forces such as those that support the vertically movable member 12. These static forces tend to be asymmetrical around the vertical axis and in particular the vertical direction of the suspension line 30. In order to achieve proper display of the Coriolis force it is necessary that these forces be balanced or compensated for as closely as possible since they impart stress upon the vertically movable member 12 and can hide or otherwise prevent full illustration of the true Coriolis force.

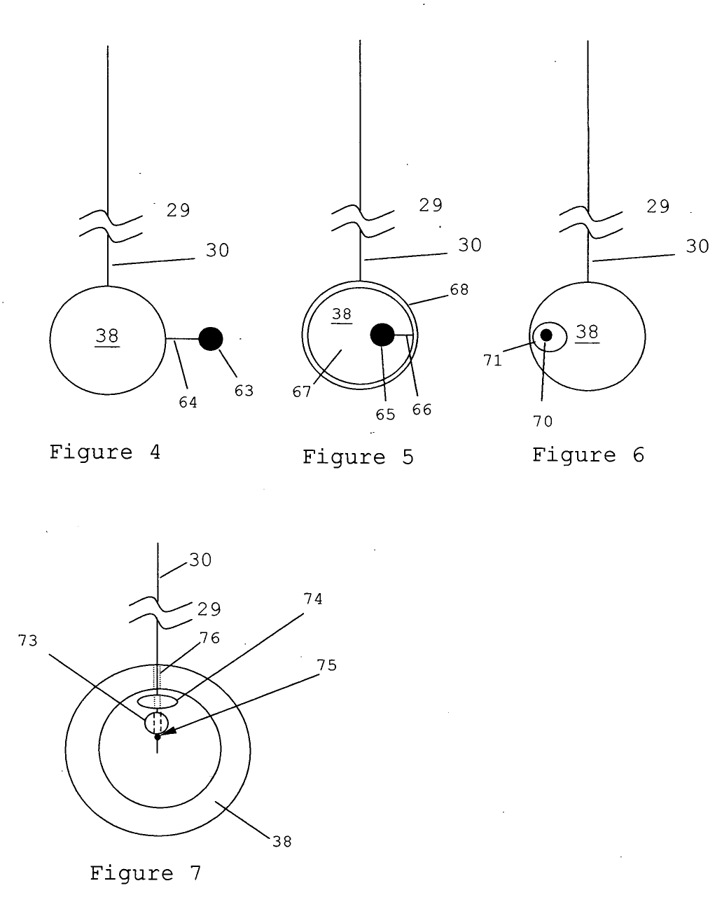

One manner which has been found very effective to correct or compensate for these static forces if by the attachment of a small mass with respect to the bob in such a way that it causes a small amount of mechanical “jitter” or “noise” to the pendulum swinging motion. FIGS. 4-6 show various configurations as to how such mechanical jitter can be utilized to supplement the operation of the present invention and help compensate the static forces.

In particular FIG. 4 shows an external mass means 63 which is secured to the exterior of the bob 38 by an external resilient attachment means 64 such as a spring means or the like. As the bob 38 moves through its cyclical pattern the external mass 63 will move in various directions and subject to various forces such as to introduce mechanical jittering or noise to the swing itself and facilitate stability thereof.

FIG. 5 shows an alternative configuration for the means for introducing mechanical jitter which makes use of an internal mass means 65 connected by an internal resilient attachment means 66 such as a spring. With this configuration the bob 38 will be hollow and in this manner will define a bob chamber means 67. The internal mass 65 and the internal spring 66 are both connected to the interior of the bob within the bob chamber means 67 for the purpose of introducing mechanical jitter or noise to the movement of the bob as it cyclically moves through standard pendulum movement.

The hollow bob 68 shown in FIG. 5 can also define a much smaller interior chamber and in that manner not be fully hollow and still introduce the necessary mechanical noise and jitter to the present invention. This is shown best in FIG. 6 wherein the bob 38 defines a bob void means 71 therein. The bob void 71 is an opening or chamber within the bob which is less than as large as it could be and is particularly designed for usage with a free mass 70 which is not connected to the bob 38 in any manner whatsoever. In this manner the free mass 70 is free to move throughout the bob void 71. The sizing of the bob void 71 is an important consideration in this design in order to vary the amplitude and directions of mechanical noise or jitter being introduced. FIGS. 4, 5 and 6 all provide unique means for introduction of such mechanical jitter to facilitate overcoming of static or other friction forces in order to fully illustrate the Coriolis force by pendulum movement of the present invention.

FIG. 7 provides an alternative specific configuration for attachment of the bob 38 with respect to the lowermost end of the suspension line 30. Preferably the bob 38 will define a bob chamber means 67 therewithin as well as a longitudinally extending bob opening means 76 extending therethrough. Bob opening means 76 will preferably by cylindrical in shape and will extend through the bob 38 completely into the bob chamber means 67 defined therewithin and in this manner the bob opening means 76 and the bob chamber means 67 will both be in fluid flow communication with respect to one another. In order to secure the suspension line 30 to the bob 38 a securement member 75 will be affixed in the lower portion of the suspension 30 at a position within the bob chamber 67. This securement means 75 can comprise a simple knot or a drop of glue which is allowed to cure and form in a droplet format surrounding the suspension line 30 at a position within the bob chamber means 67 below the bob opening means 76. In this manner this securement member 75 in the form of a piece of glue will be larger than the diameter of the bob opening means 76 and thereby prevent disengagement of the suspension line 30 from the bob 38. It is also particularly advantageous to isolate the bob 38 from axial forces which can be exerted thereon resulting from twisting or rotation of the suspension line 30. Such rotation is common in these types of pendulums and this rotation will present unwanted rotational forces on the bob 38 from the suspension line 30. Force isolation between the bob 38 and the suspension line 30 is achieved with the apparatus shown in FIG. 7 by the inclusion of two adjacently positioned bearings 73 and 74. First bearing 73 is positioned immediately adjacent to the knot or glue means 75 and the second bearing means 74 is positioned between the first bearing 73 and the inner wall of the hollow bob 68 in the area immediately surrounding the bob opening means 76 therewithin. These two bearings will significantly enhance the isolation of the bob 38 from rotational or axial forces exerted thereupon when the suspension line 30 becomes rotated for one reason or another.

It should be appreciated that one of the most advantageous configurations of the apparatus of the present invention is where the sensor 18 and the control means 40 as shown schematically in FIG. 1 are formed as a single integral unit. The components required for sensing movement of the vertically movable member 12 and for controlling movement of the vertically movable member 12 include many common components and it is an important advantage of the present invention that the forming of the sensor in the control means as a single sensor/control device is within contemplation of the present invention.

While particular embodiments of this invention have been shown in the drawings and described above, it will be apparent that many changes may be made in the form, arrangement and positioning of the various elements of the combination. In consideration thereof it should be understood that preferred embodiments of this invention disclosed herein are intended to be illustrative only and not intended to limit the scope of the invention.

I claim:

1. A driven pendulum apparatus comprising:
A. a vertically movable member;
B. a drive means operatively connected with respect to said vertically movable member and adapted to be actuated for powering vertical movement thereof;
C. a sensing means operatively attached with respect to said vertically movable member to sense vertical movement thereof responsive to forces exerted thereon;
D. an adapter member secured to said vertically movable member to be movable therewith vertically;
E. a mounting membrane means detachably mounted to said adapted member and extending downwardly therefrom being movable vertically therewith, said mounting membrane means being formed of a flexible resilient material, said mounting membrane means defining a membrane aperture means therein;
F. a suspension line means positioned extending through said membrane aperture means defined in said mounting membrane means and extending outwardly and downwardly therefrom;
G. a line securement means for detachably retaining of said suspension line means in position extending through said membrane aperture means of said mounting membrane means and further extending downwardly therefrom; and
H. a bob means detachably securable with respect to said suspension line means at a position below said membrane aperture means to facilitate cyclical pivotal movement of the pendulum.

2. A driven pendulum apparatus as defined in claim 1 wherein said drive means is operative to drive said vertically movable member up and down inductively.

3. A driven pendulum apparatus as defined in claim 1 wherein said drive means includes a coil means which is responsive to actuation thereof to generate an electromagnetic field for inductively driving said vertically movable member to move vertically.

4. A driven pendulum apparatus as defined in claim 1 further comprising a control means operatively connected with respect to said drive means and said sensor means for controlling operation of the driven pendulum.

5. A driven pendulum apparatus as defined in claim 4 wherein said control means is configurable in an operative mode wherein said drive means is rendered operative to cyclically drive said vertically movable member for driving of the pendulum and wherein said sensing means is rendered inoperative.

6. A driven pendulum apparatus as defined in claim 4 wherein said control means is configurable in a calibration mode wherein said sensing means is rendered operative to sense vertical movement of said vertically movable member in order to determine the natural oscillating frequency of the pendulum and wherein said drive means is rendered inoperative.

7. A driven pendulum apparatus as defined in claim 1 further comprising a pendulum housing and wherein said vertically movable member is flexibly resiliently mounted with respect to said pendulum housing to facilitate vertical movement thereof for driving of the pendulum.

8. A driven pendulum apparatus as defined in claim 1 wherein said mounting membrane means comprises a nipple member extending downwardly from said adapter member.

9. A driven pendulum apparatus as defined in claim 1 wherein said adapter member comprises:
A. an adapter body securable directly with respect to said vertically movable member to be movable therewith; and
B. a mounting cap detachably securable with respect to said adapter body and positionable extending around said mounting membrane means for detachably affixing thereof with respect to said adapter body.

10. A driven pendulum apparatus as defined in claim 9 wherein said mounting cap defines a cap opening means therein adapted to receive said mounting membrane means extending outwardly therethrough to facilitate mounting thereof with respect to said adapter body.

11. A driven pendulum apparatus as defined in claim 9 wherein said adapter body includes body thread means and wherein said mounting cap includes cap thread means, said body thread means and said cap thread means being engageable with respect to one another to facilitate detachable securement of said mounting cap and said mounting membrane means to said adapter body.

12. A driven pendulum apparatus as defined in claim 11 wherein said mounting membrane means includes a mounting rim means adapted to be positioned between said mounting cap and said adapter body to facilitate detachably securement of said mounting membrane means with respect to said adapter body and said vertically movable member.

13. A driven pendulum apparatus as defined in claim 1 wherein said mounting membrane means is made of flexibly resilient rubber.

14. A driven pendulum apparatus as defined in claim 1 wherein said line securement means includes a retaining bead having a size larger than said membrane aperture means defined in said mounting membrane means and being securable to said suspension line means at a position above said membrane aperture means to facilitate retaining of said suspension line means in position extending downwardly therethrough.

15. A driven pendulum apparatus as defined in claim 14 wherein said retaining bead defines a bead hole means extending therethrough which is adapted to receive said suspension line means extending therethrough to facilitate detachably securement thereto.

16. A driven pendulum apparatus as defined in claim 15 wherein said bead hole means is smaller than said suspension line means at room temperature and is larger than said suspension line means at a temperature higher than room temperature in order to facilitate securement with respect to said suspension line means extending therethrough.

17. A driven pendulum apparatus as defined in claim 16 wherein said retaining bead is made of a metallic material and is responsive to being heated to enlarge said bead hole means extending therethrough to a size larger than said suspension line means to allow threading of said suspension line means therethrough and to facilitate gripping thereof responsive to cooling of said retaining bead means which simultaneously decreases the size of said bead hole means.

18. A driven pendulum apparatus as defined in claim 17 wherein said retaining bead means is made of brass.

19. A driven pendulum apparatus as defined in claim 1 wherein said suspension line means is made of an alloy of nickel and titanium to facilitate controlled flexibility thereof.

20. A driven pendulum apparatus as defined in claim 19 wherein said suspension line means is made of nitinol.

21. A driven pendulum apparatus as defined in claim 1 further comprising a temperature monitoring means operatively connected with respect to said control means and wherein said control means is operative to increase the period of cyclical driving of said driving means responsive to an increase in ambient temperature and wherein said control means is operative to decrease the period of cyclical driving of said driving means responsive to a decrease in ambient temperature.

22. A driven pendulum apparatus as defined in claim 1 wherein said drive means is operative to allow gravitational force to drive said vertically movable member downwardly responsive to said bob means reaching the highest point in cyclical pivotal movement thereof and wherein said drive means is operative to drive said vertically movable member upwardly responsive to said bob means reaching the lowest point in cyclical pivotal movement thereof.

23. A driven pendulum apparatus as defined in claim 1 wherein said drive means is operative to drive said vertically movable member downwardly immediately prior to said bob means reaching the highest point in cyclical pivotal movement thereof and wherein said drive means is operative to drive said vertically movable member upwardly immediately prior to said bob means reaching the lowest point in cyclical pivotal movement thereof.

24. A driven pendulum apparatus as defined in claim 1 further comprising an indicator light means operative in calibration mode to signal responsive to said bob means reaching the highest point in cyclical pivotal movement thereof and being operative in operation mode to signal responsive to driving of said vertically movable member.

25. A driven pendulum apparatus as defined in claim 1 wherein said control means includes a manual adjustment means to facilitate manual fine tuning of the frequency of operation of said drive means.

26. A driven pendulum apparatus as defined in claim 1 wherein said sensing means comprises an inductively powered sensing device.

27. A driven pendulum apparatus as defined in claim 1 wherein said line securement means includes a retaining bead and said mounting membrane means defines a retaining socket means therewith adapted to receive said retaining bead movable and detachably mounted therewithin to facilitate pivotal movement of said suspension line means with respect to said mounting membrane means during pivotal movement thereof during pendulum operation.

28. A driven pendulum apparatus as defined in claim 1 wherein said bob means includes:
A. an external resilient attachment means secured to said bob means and extending outwardly therefrom, said external resilient attachment means being flexibly resilient; and
B. an external mass means attached to said external resilient attachment means spatially disposed from said bob means to induce mechanical jittering motion to said bob means responsive to periodic movement thereof.

29. A driven pendulum apparatus as defined in claim 1 wherein said bob means is hollow and defines a bob chamber means therewithin, said bob means including:
A. an internal resilient attachment means secured to said bob means within said bob chamber means thereof and extending inwardly therefrom into said bob chamber means, said internal resilient attachment means being flexibly resilient; and
B. an internal mass means attached to said internal resilient attachment means and positioned within said bob chamber means in order to be movable responsive to periodic movement of said bob means to induce mechanical jittering motion to said bob means.

30. A driven pendulum apparatus as defined in claim 1 wherein said bob means defines a bob void means therewithin, said bob means including an internal mass means positioned within said bob void means and being freely movable therewithin responsive to periodic movement of said bob means to induce mechanical jittering motion to said bob means.

31. A driven pendulum apparatus as defined in claim 1 wherein said bob means is hollow and defines a bob chamber means therewithin, said bob means further defining a bob opening means extending therethrough in fluid flow communication with respect to said bob chamber means, said driven pendulum apparatus further including a bob attachment means comprising:
A. a securement member attached to said suspension line means at a position within said bob chamber means, said securement member being larger than said bob opening means to facilitate retaining of said suspension line means extending through said bob opening means into said bob chamber means;
B. a first bearing means extending around said suspension line means at a position above said securement member and below said bob means to facilitate isolation of movement between said bob means and said suspension line means;
C. a second bearing means extending around said suspension line means at a position above said first bearing means and below said bob means to further facilitate isolation of movement between said bob means and said suspension line means.

32. A driven pendulum apparatus as defined in claim 4 wherein said sensor means and said control means are defined as a single integral device.

33. A driven pendulum apparatus comprising:
A. a vertically movable member;
B. a drive means operatively connected with respect to said vertically movable member and adapted to be actuated for inductively powering vertical movement thereof, said drive means including a coil means which is operative to generate an electromagnetic field responsive to actuation thereof to power vertical movement of said vertically movable member;
C. a sensing means operatively attached with respect to said vertically movable member to sense vertical movement thereof responsive to forces exerted thereon;
D. an adapter member secured to said vertically movable member to be movable therewith vertically, said adapter member including:
(1) an adapter body securable directly with respect to said vertically movable member to be movable therewith;
(2) a mounting cap detachably securable with respect to said adapter body;
E. a mounting membrane means comprising a nipple member detachably mounted between said mounting cap and said adapter body of said adapted member and extending downwardly therefrom being movable vertically therewith, said mounting membrane means being formed of a flexible resilient rubber material, said mounting membrane means defining a membrane aperture means therein;
F. a suspension line means positioned extending through said membrane aperture means defined in said mounting membrane means and extending outwardly and downwardly therefrom;
G. a line securement means for detachably retaining of said suspension line means in position extending through said membrane aperture means of said mounting membrane means and further extending downwardly therefrom, said line securement means including a retaining bead having a size larger than said membrane aperture means defined in said mounting membrane means and being securable to said suspension line means at a position above said membrane aperture means to facilitate retaining of said suspension line means in position extending downwardly therethrough, said retaining bead defining a bead hole means extending therethrough which is adapted to receive said suspension line means extending therethrough to facilitate detachably securement thereto;
H. a bob means detachably securable with respect to said suspension line means at a position below said membrane aperture means to facilitate cyclical pivotal movement thereof;
I. a control means operatively connected with respect to said drive means and said sensor means for controlling cyclical operation of said bob of the driven pendulum, said control means being initially configurable in a calibration mode wherein said sensing means is rendered operative to sense vertical movement of said vertically movable member in order to determine the natural oscillating frequency of the pendulum and wherein said drive means is rendered inoperative, said control means being thereafter configurable in an operative mode wherein said drive means is rendered operative to cyclically drive said vertically movable member for driving of said bob of the pendulum with said sensing means is rendered inoperative;
J. a pendulum housing with said vertically movable member flexibly resiliently mounted with respect to said pendulum housing to facilitate vertical movement thereof; and
K. a temperature monitoring means operatively connected with respect to said control means with said control means being operative to increase the period of cyclical driving of said driving means responsive to an increase in ambient temperature and wherein said control means is operative to decrease the period of cyclical driving of said driving means responsive to a decrease in ambient temperature.

34. Method of operation of a pendulum comprising:
A. initiating cyclic movement of the pendulum while connected to a vertically movable member thereabove;
B. measuring of forces exerting upon a vertically movable member over time;
C. calculating of the natural frequency of oscillation of the pendulum from the measured forces over time; and
D. powering cyclical driving of the vertically movable member vertically at a frequency approximately equal to twice the calculated natural frequency of the pendulum.

35. A method of operation of a pendulum as defined in claim 34 wherein said powering cyclical driving of the vertically movable member is timed to move downwardly approximately when the pendulum bob is at the highest point of movement thereof and is timed to move upwardly approximately when the pendulum bob is at the lowest point of movement thereof.

36. A method of operation of a pendulum as defined in claim 34 wherein said powering cyclical driving of the vertically movable member is timed to move downwardly immediately prior to the pendulum bob reaching the highest point of movement thereof and is timed to move upwardly immediately prior to the pendular bob reaching the lowest point of movement thereof.

37. A method of operation of a pendulum as defined in claim 34 wherein said powering cyclical driving of the vertically movable member is timed to move downwardly when the horizontal component of movement of the pendulum bob is approximately zero.

38. A method of operation of a pendulum as defined in claim 34 wherein said powering cyclical driving of the vertically movable member is timed to move upwardly when the vertical component of motion of the pendulum bob is approximately zero.

39. A method of operation of a pendulum as defined in claim 34 wherein said powering cyclical driving of the vertically movable member is performed inductively by generating of an electromagnetic field around the vertically movable member.

40. A method of operation of a pendulum as defined in claim 34 further comprising monitoring of the ambient temperature and increasing the period of cyclical driving of said driving means responsive to an increase in ambient temperature and decreasing the period of cyclical driving of said driving means responsive to a decrease in ambient temperature.
